(19) United States
(12) Patent Application Publication
(10) Pub. No.: US 2018/0198353 A1
(43) Pub. Date: Jul. 12, 2018

(54) METHOD FOR MANUFACTURING STATOR AND METHOD FOR MANUFACTURING ROTATING ELECTRICAL MACHINE

(71) Applicants: AISIN AW CO., LTD, Anjo-shi, Aichi-ken (JP); HAYASHIKOGYOSYO CO., LTD., Nakatsugawa-shi, Gifu-ken (JP)

(72) Inventors: Toru KUROYANAGI, Okazaki (JP); Ko KAJITA, Mizunami (JP); Takahiko HOBO, Nakatsugawa (JP)

(73) Assignees: AISIN AW CO., LTD, Anjo-shi, Aichi-ken (JP); HAYASHIKOGYOSYO CO., LTD., Nakatsugawa-shi, Gifu-ken (JP)

(21) Appl. No.: 15/742,279

(22) PCT Filed: Aug. 26, 2016
(86) PCT No.: PCT/JP2016/075044

§ 371 Date: Jan. 5, 2018

(30) Foreign Application Priority Data
Aug. 28, 2015 (JP) 2015-168661

(51) Int. Cl. H02K 15/04; H02K 15/085; H02K 3/12; H02K 15/06; H02K 3/28; H02K 15/00; H02K 1/16; H02K 15/03

(52) U.S. Cl. CPC H02K 15/0464; H02K 15/085; H02K 3/12; H02K 15/03; H02K 3/28; H02K 15/0087; H02K 1/165; H02K 15/062

(57) ABSTRACT

A method for manufacturing a stator that includes attaching a coil portion to slots by pivoting the coil portion about a connecting wire in a state in which a plurality of the coil portions are connected together by the connecting wire for each phase, the coil portions including a first coil portion that includes one first slot-housed portion to be arranged on a radially inner side of a first slot of a stator core and the other first slot-housed portion to be arranged on a radially outer side of a second slot provided at a position spaced away from the first slot in a circumferential direction, the other first slot-housed portion being spaced away from the one first slot-housed portion in the circumferential direction.

### BACKGROUND

The present disclosure relates to a method for manufacturing a stator and a method for manufacturing a rotating electrical machine.

Hitherto, there is known a rotating electrical machine including double-layer lap winding coils arranged in slots such that one of a pair of slot-housed portions of the coil that are arranged in the slots is arranged on an outer side of the slot in a radial direction and the other of the pair of slot-housed portions is arranged on an inner side of the slot in the radial direction. Such a rotating electrical machine is disclosed in, for example, Japanese Patent Application Publication No. 2009-195004 (JP 2009-195004 A).

When coil assemblies having a plurality of double-layer lap winding coils connected together by connecting wires are arranged in the slots for a plurality of phases (for example, three phases), the double-layer lap winding coils included in the coil assemblies of the respective phases are alternately attached to the slots one by one in order of the respective phases.

### SUMMARY

in the rotating electrical machine including the double-layer lap winding coils arranged in the slots as described in Japanese Patent Application Publication No. 2009-195004 (JP 2009-195004 A), however, when the double-layer lap winding coils included in the coil assemblies of the respective phases are alternately attached to the slots one by one in order of the respective phases, a problem arises in that the connecting wires of the respective phases that connect the double-layer lap winding coils together are woven (for example, in a case of three phases, the connecting wires of the three phases are twisted into braids) depending on how the double-layer lap winding coils are attached.

An exemplary aspect of the present disclosure provides a method for manufacturing a stator and a method for manufacturing a rotating electrical machine, in which connecting wires of a plurality of phases can be prevented from being twisted and woven when coil portions are attached to slots.

A method for manufacturing a stator according to a first aspect of the present disclosure includes attaching a coil portion to slots by pivoting the coil portion about a connecting wire in a state in which a plurality of the coil portions are connected together by the connecting wire for each phase, the coil portions including a first coil portion that includes one first slot-housed portion to be arranged on a radially inner side of a first slot of a stator core and the other first slot-housed portion to be arranged on a radially outer side of a second slot provided at a position spaced away from the first slot in a circumferential direction, the other first slot-housed portion being spaced away from the one first slot-housed portion in the circumferential direction.

As described above, the method for manufacturing a stator according to the first aspect of the present disclosure includes attaching the coil portion to the slots by pivoting the coil portion about the connecting wire in the state in which the plurality of the coil portions including the first coil portion are connected together by the connecting wire for each phase. Therefore, when the coil portion is attached to the slots, the connecting wire of each phase is simply pivoted without changing the arrangement position of the connecting wire of each phase from a state corresponding to a state in which the plurality of coil portions attached to the slots are detached one by one by being pivoted about the connecting wire. Thus, the coil portion can be attached to the slots. As a result, the connecting wires of the plurality of phases can be prevented from being twisted and woven into braids when the coil portion is attached to the slots.

A method for manufacturing a rotating electrical machine according to a second aspect of the present disclosure includes attaching a coil portion to slots by pivoting the coil portion about a connecting wire in a state in which a plurality of the coil portions are connected together by the connecting wire for each phase, the coil portions including a first coil portion that includes one first slot-housed portion to be arranged on a radially inner side of a first slot of a stator core and the other first slot-housed portion to be arranged on a radially outer side of a second slot provided at a position spaced away from the first slot in a circumferential direction, the other first slot-housed portion being spaced away from the one first slot-housed portion in the circumferential direction, and arranging a rotor so that the rotor faces the slots of the stator core to which the coil portions are attached.

As described above, the method for manufacturing a rotating electrical machine according to the second aspect of the present disclosure includes attaching the coil portion to the slots by pivoting the coil portion about the connecting wire in the state in which the plurality of the coil portions including the first coil portion are connected together by the connecting wire for each phase. Therefore, when the coil portion is attached to the slots, the connecting wire of each phase is simply pivoted without changing the arrangement position of the connecting wire of each phase from a state corresponding to a state in which the plurality of coil portions attached to the slots are detached one by one by being pivoted about the connecting wire. Thus, the coil portion can be attached to the slots. As a result, it is possible to provide a method for manufacturing a rotating electrical machine in which the connecting wires of the plurality of phases can be prevented from being twisted and woven into braids when the coil portion is attached to the slots.

According to the present disclosure, as described above, the connecting wires of the plurality of phases can be prevented from being twisted and woven when the coil portion is attached to the slots.

### BRIEF DESCRIPTION OF THE DRAWINGS

FIG. 1 is a plan view of a rotating electrical machine according to a first embodiment of the present disclosure.

FIG. 2 is a view illustrating a coil of the rotating electrical machine according to the first embodiment of the present disclosure.

FIG. 3 is a view illustrating a coil portion of the rotating electrical machine according to the first embodiment of the present disclosure.

FIG. 4 is a view illustrating connecting wires of the rotating electrical machine according to the first embodiment of the present disclosure as seen in a rotational axis direction.

FIG. 5 is a view illustrating the connecting wires of the rotating electrical machine according to the first embodiment of the present disclosure as seen in a radial direction.

FIG. 6 is a view illustrating insulating paper of the rotating electrical machine according to the first embodiment of the present disclosure.

FIG. 7 is a view for describing a step of forming a coil assembly according to the first embodiment of the present disclosure.

FIG. 8 is a view (view illustrating coil assemblies as seen in the rotational axis direction) for describing the step of forming the coil assembly according to the first embodiment of the present disclosure.

FIG. 9 is a view (developed view) for describing a step of arranging the coil assembly and a step of attaching the coil portion according to the first embodiment of the present disclosure.

FIG. 10 is a view (view that is seen in the radial direction) for describing the step of arranging the coil assembly and the step of attaching the coil portion according to the first embodiment of the present disclosure.

FIG. 11 is a view (1) illustrating a state in which the coil portion is attached to slots according to the first embodiment of the present disclosure.

FIG. 12 is a view (2) illustrating the state in which the coil portion is attached to the slots according to the first embodiment of the present disclosure.

FIG. 13 is a view (3) illustrating the state in which the coil portion is attached to the slots according to the first embodiment of the present disclosure.

FIG. 14 is a view for describing a state in which the coil assembly is moved according to the first embodiment of the present disclosure.

FIG. 15 is a view illustrating a state in which a stator core is rotated by an amount corresponding to a coil unit slot according to the first embodiment of the present disclosure.

FIG. 16 is a plan view of a rotating electrical machine according to a second embodiment of the present disclosure.

FIG. 17 is a view illustrating a coil of the rotating electrical machine according to the second embodiment of the present disclosure.

FIG. 18 is a view illustrating a coil portion of the rotating electrical machine according to the second embodiment of the present disclosure.

FIG. 19 is a view for describing a step of forming a coil assembly according to the second embodiment of the present disclosure.

### DETAILED DESCRIPTION OF EMBODIMENTS

Embodiments of the present disclosure are described below with reference to the drawings.

### First Embodiment

### Structure of Rotating Electrical Machine

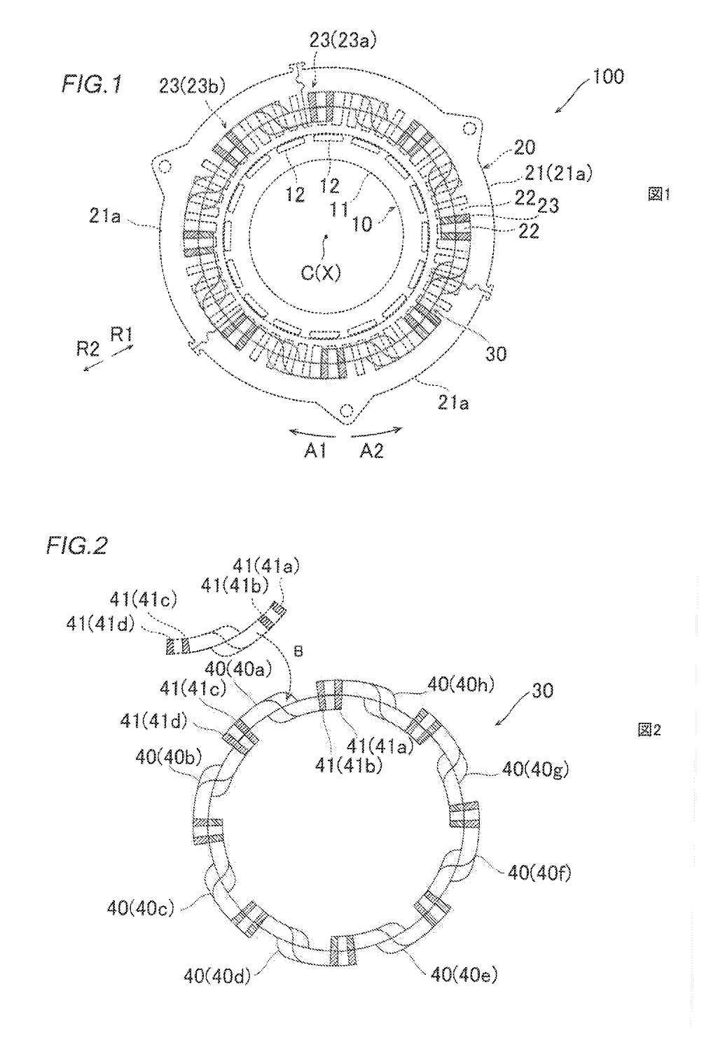

The structure of a rotating electrical machine 100 according to a first embodiment is described with reference to FIG. 1 to FIG. 6. FIG. 2 illustrates a coil 30 of one phase that is attached to a stator core 21.

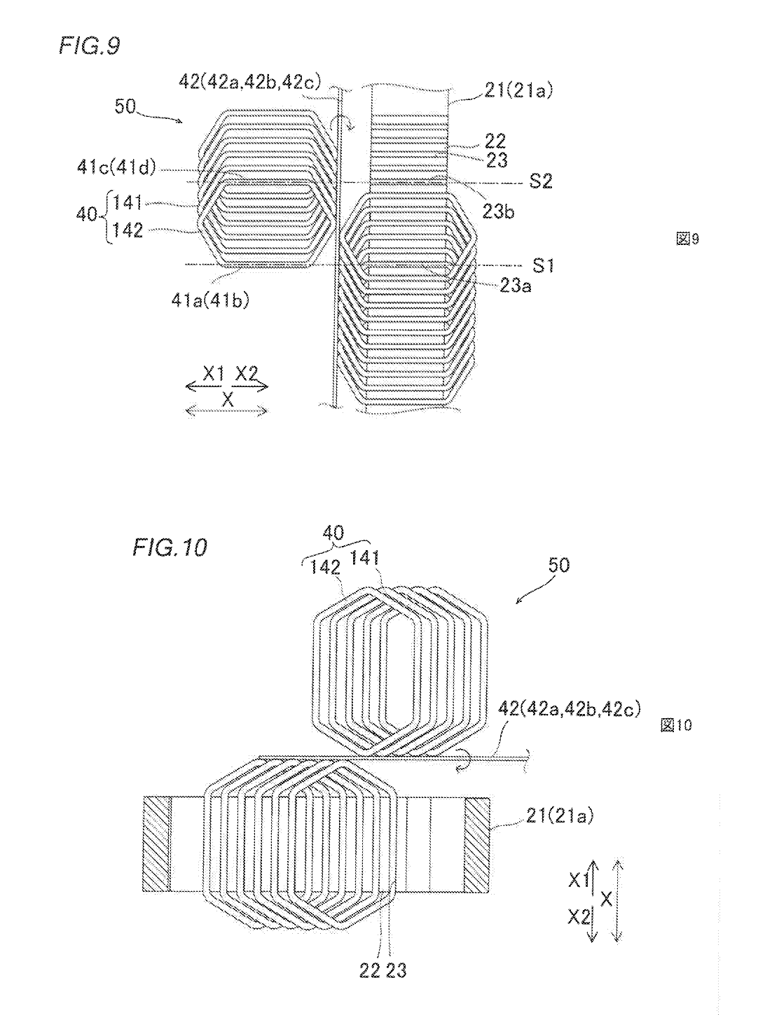

An “axial direction” herein means a direction along a rotational axis of a. stator 20 (rotor 10) (X direction; see FIG. 1, FIG. 9, and the like) that is completed as the rotating electrical machine 100. Furthermore, a “circumferential direction” means a circumferential direction of the stator 20 (A1 direction or A2 direction; see FIG. 1) that is completed as the rotating electrical machine 100. Furthermore, a “radially inner side” means a direction toward the center of the stator 20 (R1 direction; see FIG. 1) that is completed as the rotating electrical machine 100. Furthermore, a “radially outer side” means a direction toward the outside of the stator 20 (R2 direction; see FIG. 1) that is completed as the rotating electrical machine 100.

As illustrated in FIG. 1, the rotating electrical machine 100 includes the rotor 10. A rotor core 11 of the rotor 10 is provided with a plurality of permanent magnets 12. The plurality of permanent magnets 12 are arranged substantially equiangularity along the circumferential direction.

Furthermore, the rotating electrical machine 100 includes the stator 20 (stator core 21) arranged so as to face the rotor core 11 in a radial direction. The stator core 21 includes a plurality of teeth 22 and a plurality of (for example, 48) slots 23 each located between adjacent teeth 22. Furthermore, the stator core 21 is divided into a plurality of (for example, three) stator core portions 21a.

The coil 30 is arranged in the slots 23 of the stator core 21. The coil 30 is structured by, for example, flat rectangular conductor wires. As illustrated in FIG. 2, the coil 30 is structured only by a plurality of (for example, eight) coil portions 40 (coil portions 40a to 40b) formed of double-layer lap winding coils each including one slot-housed portion 41 (slot-housed portions 41a and 41b) arranged on a radially inner side of one slot 23 (23a; see FIG. 1) and the other slot-housed portion 41 (slot-housed portions 41c and 41d) arranged on a radially outer side of another slot 23 (23b; see FIG. 1) provided at a position spaced away from the slot 23a in the circumferential direction. The other slot-housed portion 41 is spaced away from each of the slot-housed portions 41a and 41b in the circumferential direction. Note that each of the coil portions 40 (coil portions 40a to 40h) is an example of a “first coil portion.” Furthermore, each of the slot-housed portions 41 (41a to 41d) is an example of a “first slot-housed portion.” Note that the double-layer lap winding coil herein means a coil having the slot-housed portions 41 arranged on a radially outer side of the slot 23 and on a radially inner side of the slot 23. The slots 23a and 23b are examples of a “first slot” and a “second slot,” respectively. Furthermore, each of the slot-housed portions 41a and 41b is an example of “one first slot-housed portion.” Furthermore, each of the slot-housed portions 41c and 41d is an example of the “other first slot-housed portion.”

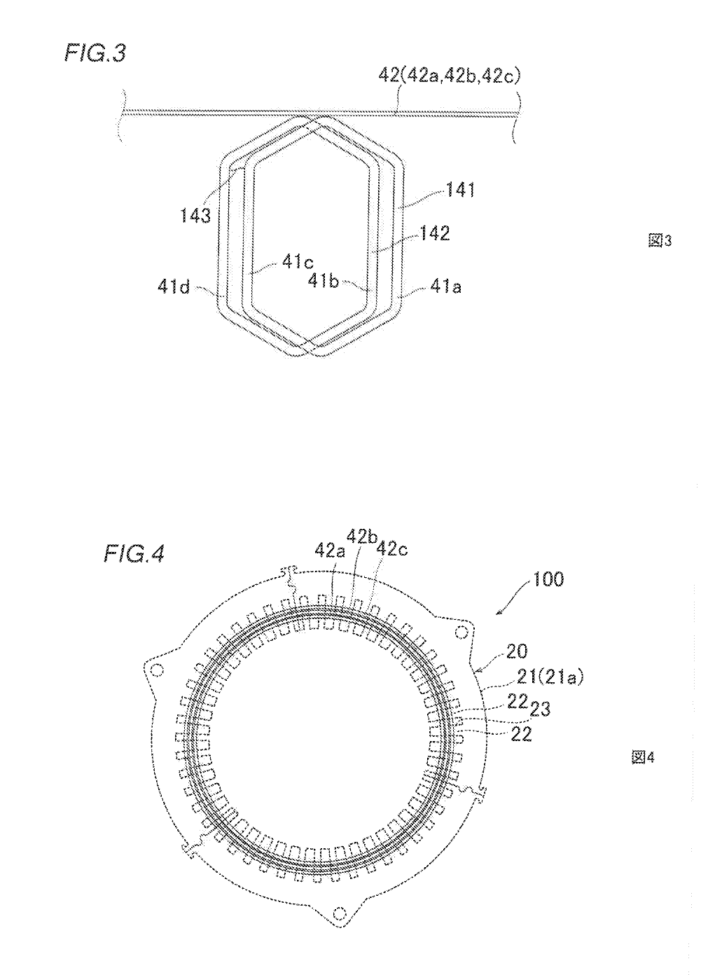

As illustrated in FIG. 3, the coil portion 40 includes a coil part 141 arranged on one side in the circumferential direction, and a coil part 142 arranged on the other side in the circumferential direction. The coil part 141 and the coil part 142 are each formed of a flat rectangular conductor wire that is wound a plurality of times, and are connected together ire series by an inter-coil connecting wire 143.

The coil 30 is structured such that a plurality of coil portions 40 formed of the double-layer lap winding coils are connected together by a connecting wire 42 for each phase. As illustrated in FIG. 4 and FIG. 5, the coils 30 are attached to the slots 23 so that the connecting wires 42 of the plurality of phases (connecting wires 42a to 42c) are arranged concentrically as seen in the rotational axis direction. Specifically, the connecting wires 42a to 42c are arranged concentrically in this order from the radially inner side toward the radially outer side.

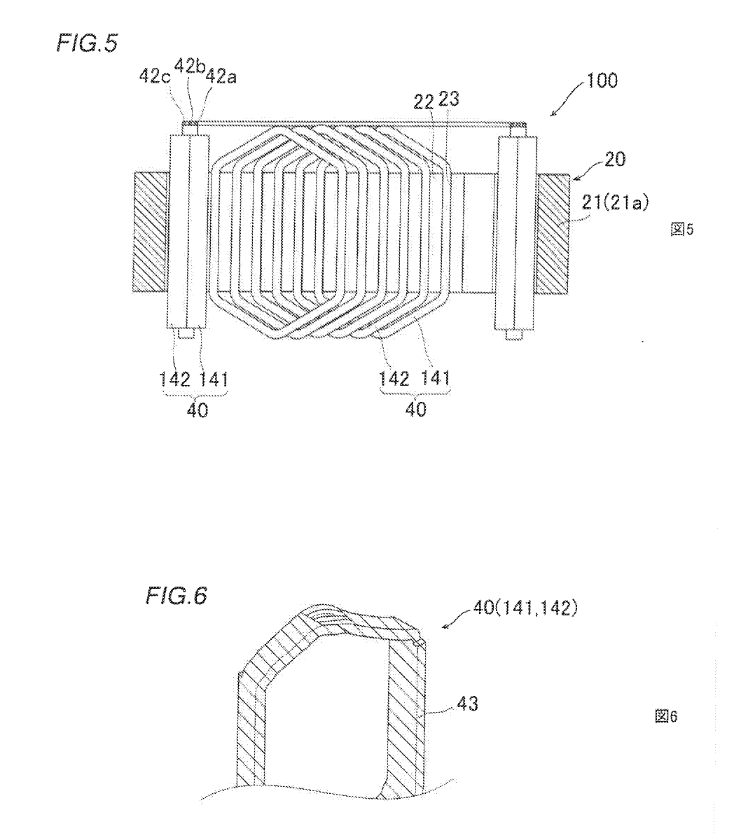

As illustrated in FIG. 6, the coil portion 40 (coil part 141 and coil part 142) is covered with insulating paper 43. Note that the insulating paper 43 is an example of an “insulating member.”

### Method for Manufacturing Rotating Electrical Machine (Stator)

Next, a method for manufacturing the rotating electrical machine 100 (stator 20) is described with reference to FIG. 1 and FIG. 7 to FIG. 15. In FIG. 1 and FIG. 7 to FIG. 15, the insulating paper 43 is omitted, but the coil portion 40 is covered with the insulating paper 43 in advance when the present disclosure is carried out.

### Step of Forming Coil Assembly

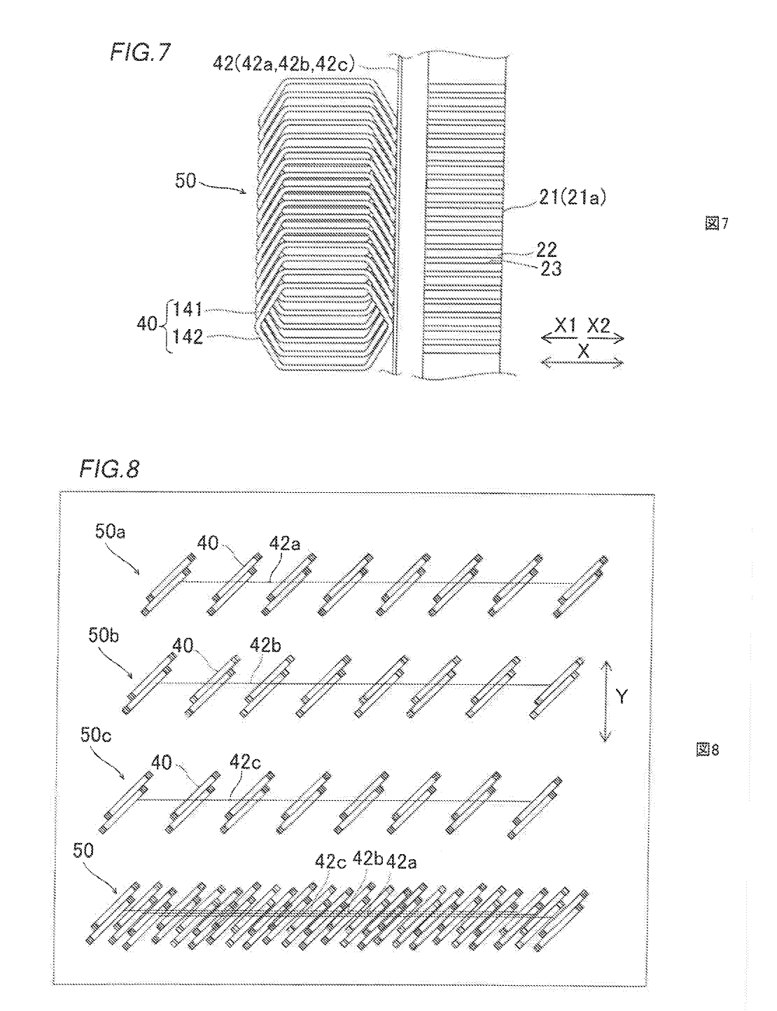

As illustrated in FIG. 7, in the first embodiment, a coil assembly 50 of the plurality of phases in a state in which the plurality of coil portions 40 formed of the double-layer lap winding coils are connected together by the connecting wire 42 for each phase is formed so as to assume a state corresponding to a state in which the plurality of coil portions 40 are detached one by one by being pivoted to one side (X1 direction side) about the connecting wire 42 from a state in which the coil portions 40 are attached to the slots 23 (see FIG. 1). Specifically, the coil assembly 50 is formed so as to assume a state in which the coil portions 40 of each phase are pivoted (reversed) to one side by 180 degrees about the connecting wire 42 of each phase (each of the connecting wires 42a to 42c) from a state in which the plurality of coil portions 40 are attached to the slots 23 as illustrated in FIG. 1.

That is, the coil assembly 50 is formed in advance as if the plurality of coil portions 40 were detached one by one instead of being actually detached one by one from a state in which the coil portions 40 are attached to the slots 23. In FIG. 7, the connecting wires 42a to 42c overlap each other in a direction away from the viewer of the drawing, and are therefore illustrated by a single line.

As illustrated in FIG. 8, the coil assembly 50 (each of coil assemblies 50a to 50c) is provided for each of the phases (U phase, V phase, and W phase). The coil assembly 50 is structured such that the coil assemblies 50a to 50c of the respective phases overlap each other in a Y direction. Furthermore, the connecting wires 42a to 42c of the respective phases are arranged adjacent to each other in the direction in which the coil portions 40 overlap each other (Y direction). In this manner, the coil assembly 50 is formed in a state in which the connecting wire 42 of each of the plurality of phases (each of the connecting wires 42a to 42c) is arranged linearly.

### Step of Arranging Coil Assembly

Next, as illustrated in FIG. 7, the coil assembly 50 of the plurality of phases is arranged at a position corresponding to a position where the plurality of coil portions 40 are detached one by one by being pivoted to one side (X1 direction side) about the connecting wire 42 from the state in which the coil portions 40 are attached to the slots 23. That is, the coil assembly 50 formed in the above-mentioned step of forming the coil assembly 50 is arranged at a position where the coil portions 40 (coil assembly 50) are arranged (position relative to the stator core 21) assuming that the coil portions 40 are reversed by 180 degrees and detached from the slots 23 with respect to the position of the connecting wire 42 after the coil portions 40 are attached (see FIG. 4 and FIG. 5).

As illustrated in FIG. 2, after the plurality of coil portions 40 are pivoted about the connecting wire 42 (arrow B in FIG. 2), the slot-housed portions 41a and 42b are arranged on the radially inner sides of the slots 23 of the stator core 21, and the slot-housed portions 41c and 42d are arranged on the radially outer sides of the slots 23 (23b) provided at the positions spaced away in the circumferential direction from the slots 23 (23a) where the slot-housed portions 41a and 42b are arranged. That is, before the coil portions 40 are pivoted about the connecting wire 42 (before the coil portions 40 are reversed by 180 degrees), the slot-housed portions 41a and 42b of each of the coil portions 40 are arranged on the radially outer sides with respect to the slot-housed portions 41c and 42d as illustrated by the coil portion 40 indicated by dotted lines in FIG. 2 unlike the state after the coil portions 40 are pivoted about the connecting wire 42.

As illustrated in FIG. 9, each of the slot-housed portions 41a and 42b of the coil portion 40 is arranged on a plane S1 connecting the slot 23 (23a) and the center of the stator core 21 together, and each of the slot-housed portions 41c and 42d of the coil portion 40 is arranged on a plane S2 connecting the slot 23b and the center of the stator core 21 together. FIG. 9 is a view of the stator core 21 that is developed on a plane, and therefore the plane S1 and the plane S2 are planes perpendicular to the drawing sheet. In actuality, the stator core 21 has an annular shape, and therefore the plane S1 and the plane 52 intersect each other at a rotational center of the rotor 10 (C; see FIG. 1).

### Step of Attaching Coil Portion

Subsequently in the first embodiment, as illustrated in FIG. 9, the coil portion 40 is attached to the slots 23 by being pivoted to the other side (X2 direction side) about the connecting wire 42 of each of the plurality of phases (each of the connecting wires 42a to 42c). Specifically, the coil portion 40 of each phase is attached to the slots 23 of the divided stator core portion 21a by being reversed to the other side by 180 degrees about the connecting wire 42 of each phase (each of the connecting wires 42a to 42c).

Specifically, as illustrated in FIG. 10, the coil portion 40 is attached to the slots 23 of the stator core portion 21a such that the coil assembly 50 having the connecting wire 42 arranged linearly is arranged on one side of the stator core portion 21a in the rotational axis direction and the coil portion 40 is reversed by 180 degrees from one side (X1 direction side) to the other side (X2 direction side) in the rotational axis direction. As described above, the coil portion 40 is covered with the insulating paper 43 in a state before the coil portion 40 is attached. In the first embodiment, the coil portion 40 covered with the insulating paper 43 is attached to the slots 23 by being pivoted to the other side about the connecting wire 42 of each of the plurality of phases (each of the connecting wires 42a to 42c).

In the first embodiment, the coil assembly 50 is formed in such a state that the connecting wire 42 of each of the plurality of phases (each of the connecting wires 42a to 42c) is arranged linearly. As illustrated in FIG. 9, the coil portions 40 of the coil assembly 50 in the state in which the connecting wire 42 (each of the connecting wires 42a to 42c) is arranged linearly are sequentially attached to the slots 23 by being pivoted to the other side about the connecting wire 42 of each of the plurality of phases (each of the connecting wires 42a to 42c).

In the first embodiment, as illustrated in FIG. 4 and FIG. 5, the coil portions 40 are attached to the slots 23 by being pivoted to the other side about the connecting wire 42 of each of the plurality of phases (each of the connecting wires 42a to 42c) so that the connecting wires 42 of the plurality of phases (connecting wires 42a to 42c) are arranged concentrically as seen in the rotational axis direction.

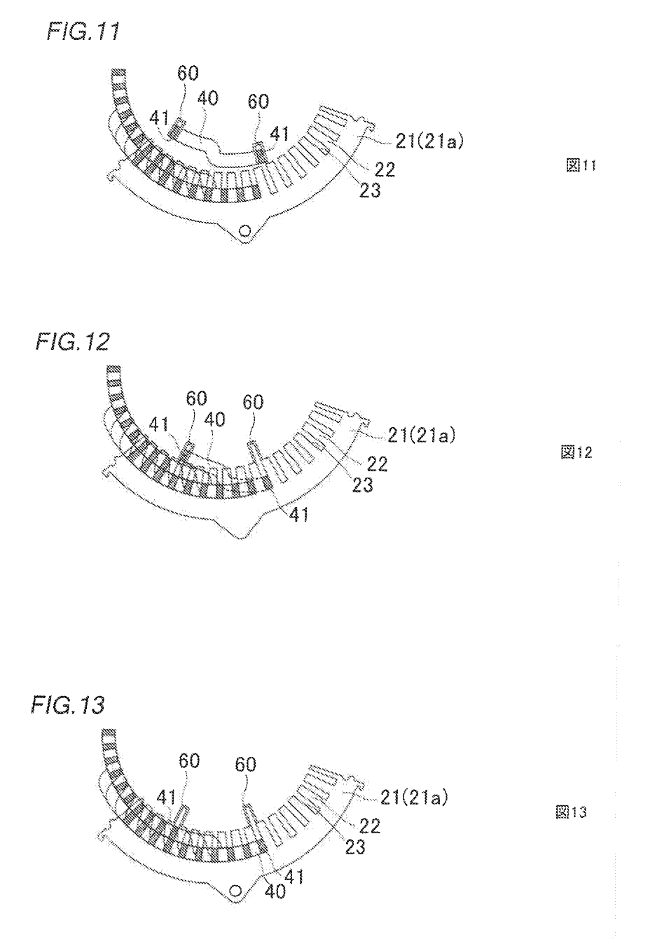

Specifically, as illustrated in FIG. 11, one coil portion 40 (coil part 141 and coil part 142) of the coil assembly 50 in a state in which the connecting wires 42 are connected is reversed and attached to a jig 60. Next, the coil portion 40 is pushed out toward the slots 23 with a guide of the jig 60. At this time, in the first embodiment, the other slot-housed portion 41 (41c and 41d) of the coil. portion 40 is attached on the radially outer side of the slot 23 as illustrated in FIG. 12, and then the one slot-housed portion 41 (41a and 41b) is attached on the radially inner side of the slot 23 as illustrated in FIG. 13.

### Step of Moving Coil Assembly and Step of Rotating Stator Core

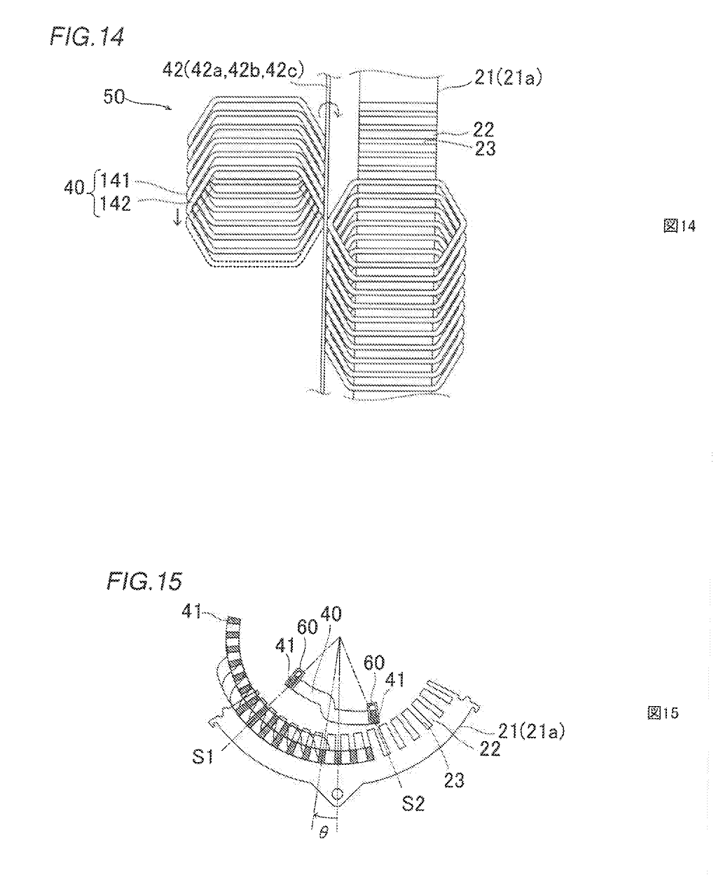

In the first embodiment, after the step of attaching the coil portion 40 to the slots 23, the coil assembly 50 is moved by an amount corresponding to one coil portion 40 (coil part 141 and coil part 142) as illustrated in FIG. 14. That is, the coil assembly 50 indicated by solid lines in FIG. 14 is moved to a position of the coil portion 40 indicated by dotted lines. Furthermore, the stator core 21 (stator core portion 21a) is rotated by an amount corresponding to a coil unit slot (by an angle θ) as illustrated in FIG. 15. That is, the coil assembly 50 is moved and the stator core 21 (stator core portion 21a) is rotated so that the position where the coil portion 40 is attached to the slots 23 (position of the jig 60) remains unchanged even when any coil portion 40 of the coil assembly 50 is attached.

The above-mentioned step of attaching the coil portion 40, the above-mentioned step of moving the coil assembly 50, and the above-mentioned step of rotating the stator core 21 are performed as many times as the number of coil portions 40. Furthermore, the above-mentioned step of attaching the coil portion 40, the above-mentioned step of moving the coil assembly 50, and the above-mentioned step of rotating the stator core portion 21a are performed for all the divided stator core portions 21a. The plurality of stator core portions 21a in a state in which the coil portions 40 are attached are assembled to form the stator 20. As illustrated in FIG. 15, at the end of the divided stator core portion 21a, one of the pair of slot-housed portions 41 of the coil portion 40 is not arranged in the slot 23 (projected). When the plurality of stator core portions 21a are assembled, the slot-housed portions 41 projected from one stator core portion 21a are attached to the slots 23 of another stator core portion 21a.

### Step of Arranging Rotor

Finally, as illustrated in FIG. 1, the rotor 10 is arranged so as to face the slots 23 of the stator core 21 to which the coil portions 40 are attached. Thus, the rotating electrical machine 100 is completed.

### Effects of First Embodiment

In the first embodiment, the following effects can be attained.

In the first embodiment, as illustrated in FIG. 9, the manufacturing method includes the step of attaching, to the slots 23, the coil portion 40 of the coil assembly 50 of the plurality of phases, which is formed so as to assume the state corresponding to the state in which the plurality of coil portions 40 are detached one by one by being pivoted to one side about the connecting wire 42 from the state in which the coil portions 40 are attached to the slots 23, by pivoting the coil portion 40 to the other side about the connecting wire 42 of each of the plurality of phases. Therefore, when the coil portion 40 is attached to the slots 23, the connecting wire 42 of each phase is simply pivoted without changing the arrangement position of the connecting wire 42 of each phase from the state corresponding to the state in which the plurality of coil portions 40 attached to the slots 23 are detached one by one by being pivoted about the connecting wire 42. Thus, the coil portion 40 can be attached to the slots 23. As a result, the connecting wires 42 of the three phases can be prevented from being twisted and woven into braids when the coil portion 40 including the double-layer lap winding coil is attached to the slots 23. Furthermore, the coil portion 40 can be attached to the slots 23 by being pivoted to the other side about the connecting wire 42 of each of the three phases. Therefore, the coil portion 40 can be attached to the slots 23 without imposing constraints of the length of the connecting wire 42 on the coil portion 40 (without moving the coil portion 40 together with the connecting wire 42). As a result, the jig 60 can be handled easily.

In the first embodiment, before the coil portion 40 is pivoted about the connecting wire 42, the slot-housed portions 41a and 42b of the coil portion 40 are arranged on the radially outer sides with respect to the slot-housed portions 41c and 42d. Thus, by pivoting (reversing by 180 degrees) each of the plurality of coil portions 40 about the connecting wire 42, the slot-housed portions 41a and 42b of the coil portion 40 can easily be arranged on the radially inner sides of the slots 23 and the slot-housed portions 41c and 42d can easily be arranged on the radially outer sides of the slots 23.

In the first embodiment, the coil portion 40 is pivoted about the connecting wire 42 in the state in which each of the slot-housed portions 41a and 42b of the coil portion 40 is arranged on the plane S1 connecting the slot 23 (23a) and the center of the stator core 21 together and each of the slot-housed portions 41c and 42d of the coil portion 40 is arranged on the plane S2 connecting the slot 23b and the center of the stator core 21 together. Therefore, even after the coil portion 40 is pivoted about the connecting wire 42, each of the slot-housed portions 41a and 42b of the coil portion 40 is arranged on the plane S1 connecting the slot 23 (23a) and the center of the stator core 21 together and each of the slot-housed portions 41c and 42d of the coil portion 40 is arranged on the plane S2 connecting the slot 23b and the center of the stator core 21 together. Accordingly, the coil portion 40 can easily be attached to the slots 23.

In the first embodiment, as illustrated in FIG. 4, the step of attaching the coil portion 40 to the slots 23 includes the step of attaching the coil portions 40 to the slots 23 by pivoting the coil portions 40 to the other side about the connecting wire 42 of each of the plurality of phases so that the connecting wires 42 of the plurality of phases are arranged concentrically as seen in the rotational axis direction. Accordingly, the connecting wires 42 of the plurality of phases that are arranged concentrically are spaced away from each other, and therefore the connecting wires 42 of the three phases can easily be prevented from being twisted and woven into braids.

In the first embodiment, as illustrated in FIG. 14 and FIG. 15, the step of moving the coil assembly 50 by an amount corresponding to one coil portion 40 and rotating the stator core 21 by an amount corresponding to the coil unit slot is provided after the step of attaching the coil portion 40 to the slots 23. The step of attaching the coil portion 40 to the slots 23 includes the step of attaching the coil portion 40 of the coil assembly 50 that is moved by the amount corresponding to one coil portion 40 to the slots 23 of the stator core 21 that is rotated by the amount corresponding to the coil unit slot. Therefore, the position where the coil portion 40 is attached to the slots 23 (position of the jig 60) is fixed. Accordingly, the attaching operation for attaching the coil portion 40 to the slots 23 can be mechanized (automated) easily.

In the first embodiment, as illustrated in FIG. 11 to FIG. 13, the step of attaching the coil portion 40 to the slots 23 includes the step of attaching the other slot-housed portion 41 of the coil portion 40 formed of the double-layer lap winding coil on the radially outer side of the other slot 23 and then attaching the one slot-housed portion 41 on the radially inner side of the one slot 23 by pivoting the coil portion 40 to the other side about the connecting wire 42 of each of the plurality of phases. Therefore, deformation of the coil portion 40 that is caused when the coil portion 40 is attached to the slots 23 can be reduced as compared to a case where the pair of slot-housed portions 41 of the coil portion 40 are simultaneously attached to the slots 23. Accordingly, it is possible to reduce an adverse effect (damage or the like) on the insulating paper 43 due to the deformation of the coil portion 40.

In the first embodiment, as illustrated in FIG. 6, the coil portion 40 is covered with the insulating paper 43. The step of attaching the coil portion 40 to the slots 23 includes the step of attaching the coil portion 40 covered with the insulating paper 43 to the slots 23 by pivoting the coil portion 40 to the other side about the connecting wire 42 of each of the plurality of phases. Accordingly, the coil portions 40 (windings) can be prevented from being damaged by directly colliding (interfering) with each other when the coil portion 40 is attached to the slots 23.

In the first embodiment, as illustrated in FIG. 1, the stator core 21 is divided into the plurality of stator core portions 21a, and the coil assembly 50 is structured only by the double-layer lap winding coils. The step of attaching the coil portion 40 to the slots 23 includes the step of attaching the coil portions 40 structured only by the double-layer lap winding coils to the slots 23 of the divided stator core portions 21a by pivoting the coil portions 40 to the other side about the connecting wire 42 of each of the plurality of phases. When the coil (coil assembly 50) is structured only by the double-layer lap winding coils, it is necessary that the slot-housed portion 41 of the coil portion 40 to be finally attached to the slots 23 be attached to the slots 23 after the slot-housed portion 41 of the coil portion 40 that is first attached to the slots 23 is temporarily removed from the slots 23. That is, when the coil portion 40 is finally attached to the slots 23, it is necessary to bypass the coil portion 40 that is first attached. In view of this, the stator core 21 is divided into the plurality of stator core portions 21a. Therefore, the divided stator core portions 21a are assembled after the coil portions 40 formed of the double-layer lap winding coils are attached to the divided stator core portions 21a. Accordingly, the coil assembly 50 structured only by the double-layer lap winding coils can be attached to the slots 23 without bypassing the coil portion 40 that is first attached.

In the first embodiment, as illustrated in FIG. 9, the step of attaching the coil portion 40 to the slots 23 includes the step of sequentially attaching the coil portions 40 to the slots 23 by pivoting the coil portions 40 to the other side about the connecting wire 42 of each of the plurality of phases (each of the connecting wires 42a to 42c) in the state in which the connecting wire 42 of each of the plurality of phases is arranged linearly. Therefore, the movement of the coil assembly 50 is linear movement unlike a case where the connecting wires 42 of the plurality of phases in the coil assembly 50 are arranged so as to be woven together. Accordingly the operation of attaching the coil portion 40 to the slots 23 can be mechanized (automated) easily.

### Second Embodiment

### Structure of Rotating Electrical Machine

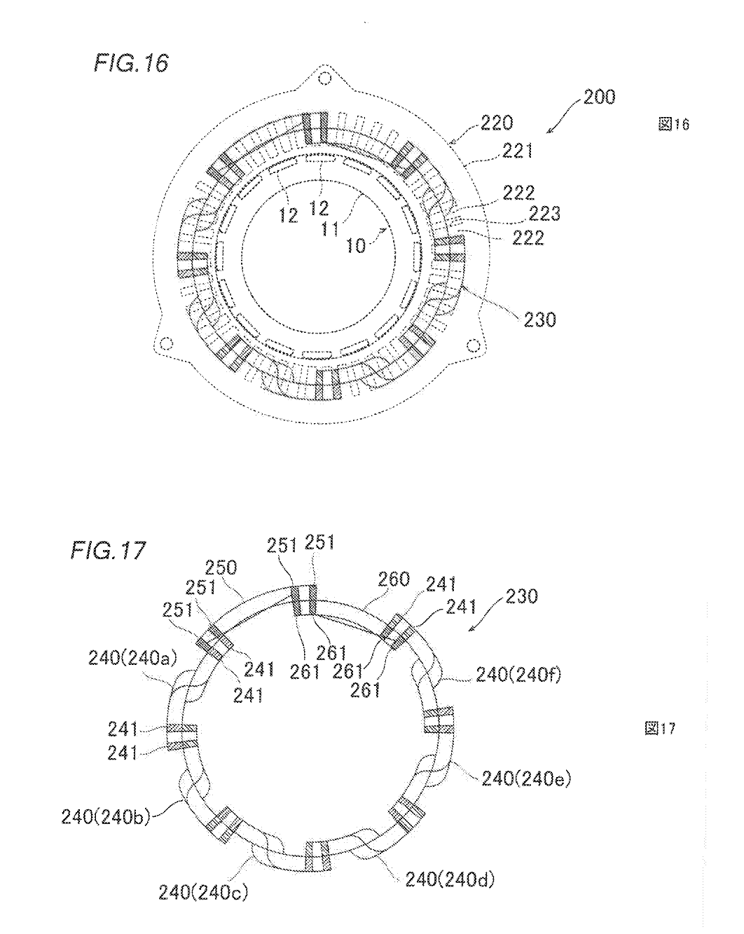

The structure of a rotating electrical machine 200 according to a second embodiment is described with reference to FIG. 16 to FIG. 18. In the rotating electrical machine 200 according to the second embodiment, a coil 230 includes a second coil portion 250 and a third coil portion 260 that are formed of single-layer lap winding coils in addition to first coil portions 240 formed of double-layer lap winding coils unlike the first embodiment described above in which the coil 30 is structured only by the coil portions 40 formed of the double-layer lap winding coils. Note that the single-layer lap winding coil herein means a coil having second slot-housed portions 251 (third slot-housed portions 261) arranged only on radially outer sides of slots 223 or on radially inner sides of the slots 223.

As illustrated FIG. 16, the rotating electrical machine 200 includes a stator 220 (stator core 221) arranged so as to face the rotor 10 (rotor core 11) in the radial direction. The stator core 221 is a single undivided stator core 221.

As illustrated in FIG. 17, in the rotating electrical machine 200, the coil 230 includes the first coil portions 240 (first coil portions 240a to 240f) formed of the double-layer lap winding coils, the second coil portion 250 formed of the single-layer lap winding coil, and the third coil portion 260 formed of the single-layer lap winding coil. The structure of the first coil portion 240 formed of the double-layer lap winding coil is similar to the structure of the coil portion 40 (see FIG. 3) formed of the double-layer lap winding coil in the first embodiment described above.

The second coil portion 250 formed of the single-layer lap winding coil includes the pair of second slot-housed portions 251 attached on the radially outer sides of the slots 223 (see FIG. 1) each provided between adjacent teeth 222. One of the pair of second slot-housed portions 251 is attached on a radially outer side with respect to a first slot-housed portion 241 of the first coil portion 240 (first coil portion 240a) formed of the double-layer lap winding coil.

The third coil portion 260 formed of the single-layer lap winding coil includes the pair of third slot-housed portions 261 attached on the radially inner sides of the slots 223. The other one of the pair of third slot-housed portions 261 is attached on a radially inner side with respect to a first slot-housed portion 241 of the first coil portion 240 (first coil portion 240f) formed of the double-layer lap winding coil.

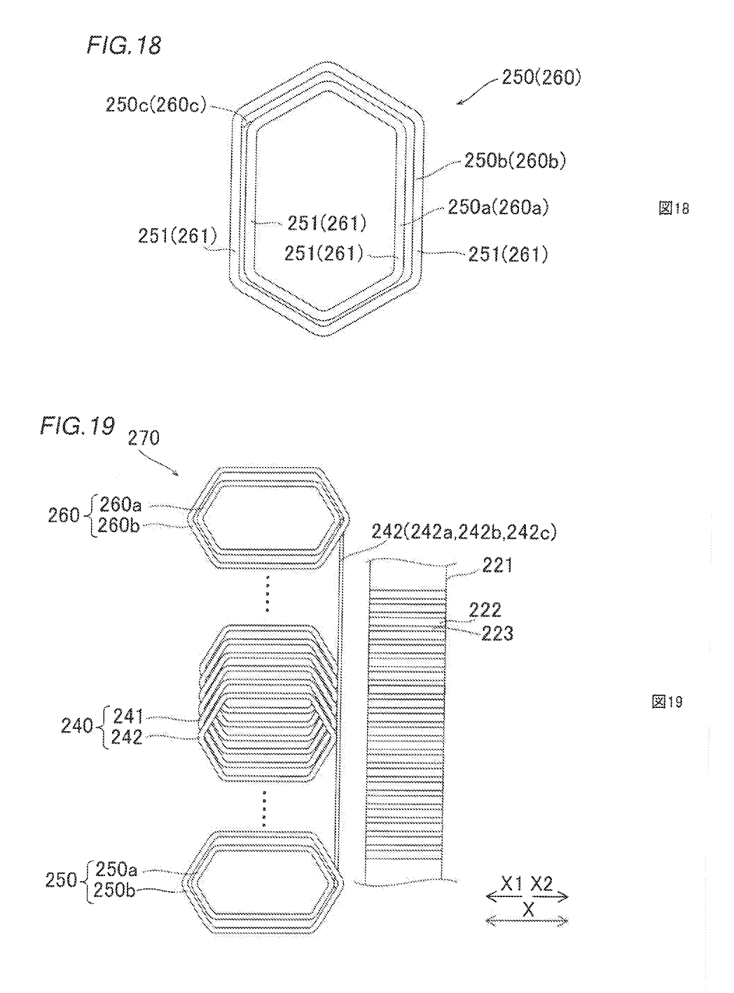

As illustrated in FIG. 18, the second coil portion 250 includes a second inner coil part 250a wound on a concentrically inner side, and a second outer coil part 250b wound on an outer side of the second inner coil part 250a (concentrically outer side), Furthermore, the third coil portion 260 includes a third inner coil part 260a wound on a concentrically inner side, and a third outer coil part 260b wound on an outer side of the third inner coil part 260a (concentrically outer side). The second inner coil part 250a and the second outer coil part 250b are connected together in series by an inter-coil connecting wire 250c. Furthermore, the third inner coil part 260a and the third outer coil part 260b are connected together in series by an inter-coil connecting wire 260c.

The other structures of the second embodiment are similar to those of the first embodiment described above.

### Method for Manufacturing Rotating Electrical Machine (Stator)

Next, a method for manufacturing the rotating electrical machine 200 (stator 220) is described with reference to FIG. 19.

### Step of Forming Coil Assembly

As illustrated in FIG. 19, a coil assembly 270 is formed so that the second coil portion 250 formed of the single-layer lap winding coil is provided at one end, the third coil portion 260 formed of the single-layer lap winding coil is provided at the other end, and the first coil portions 240 are provided between the second coil portion 250 and the third coil portion 260. The coil assembly 270 is formed similarly to the first embodiment described above. The coil assembly 270 of the plurality of phases in a state in which a plurality of coil portions are connected together by a connecting wire 242 (each of connecting wires 242a to 242c) for each phase is formed so as to assume a state corresponding to a state in which the first coil portions 240, the second coil portion 250, and the third coil portion 260 are detached one by one by being pivoted to one side (X1 direction side) about the connecting wire 242 (each of the connecting wires 242a to 242c) from a state in which the first coil portions 240, the second coil portion 250, and the third coil portion 260 are attached to the slots 223 (see FIG. 16). Furthermore, the second coil portions 250 and the third coil portions 260 formed of the single-layer lap winding coils are provided for the plurality of phases at one end and the other end of the coil assembly 270, respectively.

### Step of Arranging Coil Assembly

Next, a step of arranging the coil assembly 270 is performed similarly to the first embodiment described above.

### Step of Attaching Coil Portion

Next, in the second embodiment, the second coil portion 250 formed of the single-layer lap winding coil, which is provided at one end of the coil assembly 270, is first attached on the radially outer sides of the slots 223 of the undivided stator core 221 (see FIG. 16) by being pivoted to the other side (X2 direction side) about the connecting wire 242 (each of the connecting wires 242a to 242c). The plurality of first coil portions 240 formed of the double-layer lap winding coils are then sequentially attached to the slots 223. Subsequently, the third coil portion 260 formed of the single-layer lap winding coil, which is provided at the other end of the coil assembly 270, is attached on the radially inner sides of the slots 223 (on the radially inner side of the second slot-housed portion 251 of the second coil portion 250 and on the radially inner side of the first slot-housed portion 241 of the first coil portion 240f).

The other steps in the second embodiment, namely the step of attaching the coil portion, a step of moving the coil assembly 270, a step of rotating the stator core 221, and a step of arranging the rotor 10, are similar to those in the first embodiment described above.

### Effects of Second Embodiment

In the second embodiment, the following effects can be attained.

In the second embodiment, as illustrated in FIG. 19, the step of attaching the first coil portions 240, the second coil portion 250, and the third coil portion 260 to the slots 223 includes the step of attaching the second coil portion 250 formed of the single-layer lap winding coil, which is provided at one end of the coil assembly 270, to the slots 223 of the undivided stator core 221, attaching the first coil portions 240 formed of the double-layer lap winding coils to the slots 223, and then attaching the third coil portion 260 formed of the single-layer lap winding coil, which is provided at the other end of the coil assembly 270, to the slots 223. Thus, when the third coil portion 260 formed of the single-layer lap winding coil is attached to the slots 223, the radially inner side of the second slot-housed portion 251 of the second coil portion 250 that is first attached and the radially inner side of the first slot-housed portion 241 of the first coil portion 240f that is attached immediately before the third coil portion 260 is attached are unoccupied. Accordingly, the third coil portion 260 formed of the single-layer lap winding coil can be attached to the slots 223 without bypassing the first coil portion 240f and the second coil portion 250. That is, the first coil portions 240, the second coil portion 250, and the third coil portion 260 of the coil assembly 270 can be attached to the slots 223 without dividing the stator core 221.

The other effects of the second embodiment are similar to those of the first embodiment described above.

### Modified Examples

It should be understood that the embodiments disclosed herein are illustrative but are not limitative in all respects. For example, in the first and second embodiments described above, description is given of the example in which the coil portion is attached to the slots by being reversed to the other side by 180 degrees about the connecting wire of each of the plurality of phases. However, the present disclosure is not limited thereto. For example, the coil portion may be attached to the slots by being pivoted to the other side by an angle other than 180 degrees about the connecting wire of each of the plurality of phases.

In the first and second embodiments described above, description is given of the example in which the coil portion is attached to the slots by being reversed by 180 degrees about the connecting wire of each of the plurality of phases along the axial direction (X direction; see FIG. 9). However, the present disclosure is not limited thereto. For example, the coil portion may be pivoted along a direction that intersects the axial direction (X direction; see FIG. 9).

In the first and second embodiments described above, description is given of the example in which the coil portions are attached to the slots so that the connecting wires are arranged concentrically. However, the present disclosure is not limited thereto. In the present disclosure, the connecting wires of the plurality of phases need not be arranged concentrically as long as the connecting wires are not woven.

In the first embodiment described above, description is given of the example in which the stator core is divided into three stator core portions. However, the present disclosure is not limited thereto. For example, the stator core may be divided into any number of stator core portions other than three.

In the first and second embodiments described above, description is given of the example in which the coil portion is attached to the slots in the state in which the connecting wire of each of the plurality of phases is arranged linearly. However, the present disclosure is not limited thereto. For example, the coil portion may be attached to the slots in a state in which the connecting wire of each of the plurality of phases is arranged annularly (that is, a state identical to the state of the connecting wire after the coil portions are attached; see FIG. 4).

In the first and second embodiments described above, description is given. of the example in which the coil portion is covered with the insulating paper. However, the present disclosure is not limited thereto. For example, the coil portion may be covered with an insulating member other than the insulating paper.

In the second embodiment described above, description is given of the example in which the plurality of first coil portions formed of the double-layer lap winding coils are provided. However, the present disclosure is not limited thereto. For example, one first coil portion may be provided alone.

In the first and second embodiments described above, description is given of the example in which each of the first coil portion, the second coil portion, and the third coil portion is formed of a dual coil having two coil parts provided in a row. However, the present disclosure is not limited thereto. For example, each of the first coil portion, the second coil portion, and the third coil portion may be structured by one coil part.

In the first and second embodiments described above, description is given of the example in which the stator core is provided with 48 slots. However, the present disclosure is not limited thereto. In the present disclosure, the stator core may be provided with any number of slots other than 48.

In the first and second embodiments described above, description is given of the example in which the coil portion is structured by the flat rectangular conductor wires that are wound a plurality of times. However, the present disclosure is not limited thereto. In the present disclosure, the coil portion may be structured by relatively thin round wires that are wound a plurality of times.

1. A method for manufacturing a stator, comprising
attaching a coil portion to slots by pivoting the coil portion about a connecting wire in a state in which a plurality of the coil portions are connected together by the connecting wire for each phase, the coil portions including a first coil portion that includes one first slot-housed portion to be arranged on a radially inner side of a first slot of a stator core and the other first slot-housed portion to be arranged on a radially outer side of a second slot provided at a position spaced away from the first slot in a circumferential direction, the other first slot-housed portion being spaced away from the one first slot-housed portion in the circumferential direction.

2. The method for manufacturing a stator according to claim 1, wherein
attaching the coil portion to the slots includes attaching the coil portion to the slots by pivoting the coil portion about the connecting wire in a state in which the one first slot-housed portion of the first coil portion is arranged on a radially outer side with respect to the other first slot-housed portion before the coil portion is pivoted about the connecting wire.

3. The method for manufacturing a stator according to claim 2, wherein
attaching the coil portion to the slots includes attaching the coil portion to the slots by pivoting the coil portion about the connecting wire in a state in which the one first slot-housed portion of the first coil portion is arranged on a plane connecting the first slot and a center of the stator core together and the other first slot-housed portion of the first coil portion is arranged on a plane connecting the second slot and the center of the stator core together.

4. The method for manufacturing a stator according to claim 3, wherein
attaching the coil portion to the slots includes attaching the coil portions to the slots by pivoting the coil portions about the connecting wire of each of a plurality of the phases so that the connecting wires of the plurality of the phases are arranged concentrically as seen in a rotational axis direction.

5. The method for manufacturing a stator according to claim 4, further comprising
after attaching the coil portion to the slots, moving, by an amount corresponding to one of the coil portions, a coil assembly of the plurality of the coil portions that are connected together by the connecting wire for each phase, and rotating the stator core by an amount corresponding to a coil unit slot, wherein
attaching the coil portion to the slots includes attaching the coil portion of the coil assembly that is moved by the amount corresponding to one of the coil portions to the slots of the stator core that is rotated by the amount corresponding to the coil unit slot.

6. The method for manufacturing a stator according to claim 5, wherein
attaching the coil portion to the slots includes attaching the other first slot-housed portion of the first coil portion on the radially outer side of the second slot and then attaching the one first slot-housed portion on the radially inner side of the first slot by pivoting the coil portion about the connecting wire of each of a plurality of the phases.

7. The method for manufacturing a stator according to claim 6, wherein
the coil portion is covered with an insulating member, and
attaching the coil portion to the slots includes attaching the coil portion covered with the insulating member to the slots by pivoting the coil portion about the connecting wire of each of a plurality of the phases.

8. The method for manufacturing a stator according to claim 7, wherein
the stator core is divided into a plurality of stator core portions,
a coil assembly of the plurality of coil portions that are connected together by the connecting wire for each phase is structured only by the first coil portions, and
attaching the coil portion to the slots includes attaching the coil portions structured only by the first coil portions to the slots of the divided stator core portions by pivoting the coil portions about the connecting wire of each of the plurality of phases.

9. The method for manufacturing a stator according to claim 7, wherein
a coil assembly of the plurality of coil portions that are connected together by the connecting wire for each phase includes:
a second coil portion provided at one end of the coil assembly and including a pair of second slot-housed portions to be attached on radially outer sides of the slots, one of the pair of second slot-housed portions being attached on a radially outer side with respect to the one first slot-housed portion of the first coil portion; and
a third coil portion provided at the other end of the coil assembly and including a pair of third slot-housed portions to be attached on radially inner sides of the slots, one of the pair of third slot-housed portions being attached on a radially inner side with respect to the other first slot-housed portion of the first coil portion, and
attaching the coil portion to the slots includes attaching the second coil portion provided at the one end of the coil assembly to the slots of the undivided stator core, attaching the first coil portion to the slots, and then attaching the third coil portion provided at the other end of the coil assembly to the slots.

10. The method for manufacturing a stator according to claim 8, wherein
attaching the coil portion to the slots includes sequentially attaching the coil portions to the slots by pivoting the coil portions about the connecting wire of each of the plurality of phases in a state in which the connecting wire of each of the plurality of phases is arranged linearly.

11. A method for manufacturing a rotating electrical machine, comprising:
attaching a coil portion to slots by pivoting the coil portion about a connecting wire in a state in which a plurality of the coil portions are connected together by the connecting wire for each phase, the coil portions including a first coil portion that includes one first slot-housed portion to be arranged on a radially inner side of a first slot of a stator core and the other first slot-housed portion to be arranged on a radially outer side of a second slot provided at a position spaced away from the first slot in a circumferential direction, the other first slot-housed portion being spaced away from the one first slot-housed portion in the circumferential direction; and
arranging a rotor so that the rotor faces the slots of the stator core to which the coil portions are attached.
